(19) United States
(12) Patent Application Publication
(10) Pub. No.: US 2013/0260339 A1
(43) Pub. Date: Oct. 3, 2013

(54) HIGH TORQUE DENTAL IMPLANT SYSTEM

(71) Applicants: Michael S. Reddy, Birmingham, AL (US); Jack Lemons, Birmingham, AL (US); Nico C. Geurs, Birmingham, AL (US); Sandra Jean O'Neal, Birmingham, AL (US); Perng-Ru Liu, Birmingham, AL (US)

(72) Inventors: Michael S. Reddy, Birmingham, AL (US); Jack Lemons, Birmingham, AL (US); Nico C. Geurs, Birmingham, AL (US); Sandra Jean O'Neal, Birmingham, AL (US); Perng-Ru Liu, Birmingham, AL (US)

(73) Assignee: UAB RESEARCH FOUNDATION, Birmingham, AL (US)

(21) Appl. No.: 13/509,865

(22) PCT Filed: Nov. 17, 2010
(86) PCT No.: PCT/US2010/057015

§ 371 Date: Jun. 20, 2013

Related U.S. Application Data
(60) Provisional application No. 61/262,034, filed on Nov. 17, 2009.

(51) Int. Cl. A61C 8/00

(52) U.S. Cl. CPC A61C 8/0022; A61C 8/0069; A61C 8/0068; A61C 8/006; A61C 8/0001
USPC 433/174

(57) ABSTRACT

A dental implant system for securing a dental prosthesis within a prepared site of a jawbone in a subject having an implant configured for insertion within the prepared site of the jawbone and an abutment configured for secure attachment to the implant. The implant can have a shoulder portion having a plurality of circumferential rings and a body portion that can be threaded. The implant can have an internal cavity that is configured or otherwise adapted to receive at least a portion of the abutment.

### CROSS-REFERENCE TO RELATED APPLICATION

This application claims benefit of and priority to U.S. Provisional Patent Application Ser. No. 61/262,034, filed Nov. 17, 2009, which is incorporated by reference herein and made a part hereof.

### FIELD OF THE INVENTION

This invention relates to a dental implant system for securing a dental prosthesis therein a prepared site of a jawbone in a subject. More specifically, this invention relates to a dental implant-abutment system having a novel thread profile and surface design.

### BACKGROUND OF THE INVENTION

Known dental implants are designed to transfer biomechanical loads from the occlusal crown surface of the implant to the jawbone of a subject. However, due to improper thread pitch ratios and insufficient areas of contact between the implants and the jawbone of the subject, existing dental implants frequently fail to properly distribute these loads. As a result, loading of existing dental implants regularly leads to high stress concentrations that are not dissipated throughout the implant. In addition, known dental implants are not resistant to bacterial colonization, thereby creating additional risks of surgical complications.

Thus, there is a need in the pertinent art for a dental implant having a rigid thread design that dissipates loads throughout the thread. Additionally, there is a need in the pertinent art for a dental implant having a surface profile that permits maximized contact between the implant and the jawbone of the subject. There is a further need in the pertinent art for a dental implant that is resistant to bacterial colonization.

### SUMMARY

The invention as described herein relates to a dental implant system for securing a dental prosthesis within a prepared site of a jawbone in a subject. In one embodiment, the dental implant system can comprise an implant and an abutment. In one aspect, the implant can comprise a shoulder portion and a body portion. In another aspect, the implant can be configured for insertion within the prepared site of the jawbone, and the abutment can be configured for secure attachment to the implant. In this aspect, the abutment can be securely attached to the implant with an abutment screw. In an additional aspect, the implant can have an internal cavity configured to receive at least a portion of the abutment.

In one aspect, the shoulder portion can be tapered in a coronal direction. In this aspect, the shoulder portion can terminate to a coronal end which defines an attachment junction. In another aspect, the shoulder portion can comprise a plurality of spaced circumferential rings which encircle the outer surface of the implant and define a plurality of circumferential grooves.

In another aspect, the implant can comprise an implant body portion that terminates at an apical end. In one aspect, the implant body portion can be tapered in an apical direction. In this aspect, the diameter of the implant body portion can consistently decrease along the longitudinal axis of the implant until reaching the apical end of the implant. In one aspect, the apical end of the implant can be substantially flat. In this aspect, the apical end can be oriented substantially perpendicularly to the longitudinal axis of the implant.

In an additional aspect, the implant body portion can comprise an implant thread positioned thereon the outer surface of the implant. In one aspect, the implant thread can be a modified reverse buttress thread. In another aspect, the implant thread can have an upper loading surface, a lower loading surface, and a pitch surface positioned intermediate the upper and lower loading surfaces.

In a further aspect, the abutment can comprise a connector portion, a transition portion, and an abutment body portion. In this aspect, the connector portion can be configured for receipt by the internal cavity of the implant. In another aspect, following placement of the connector portion within the internal cavity of the implant, the transition portion can be positioned adjacent the shoulder portion of the implant. In an additional aspect, the abutment body portion can be tapered at a taper angle relative to the longitudinal axis of the abutment body portion. Optionally, in one aspect, the abutment can comprise an internal bore configured to receive the abutment screw. In a further aspect, the connector portion can be threaded.

In one aspect, the abutment can be a provisional abutment that is configured to engage a coping member. In still a further aspect, the outer surfaces of the implant and abutment can be micro- and/or nano-textured.

### DETAILED DESCRIPTION OF THE FIGURES

These and other features of the preferred embodiments of the invention will become more apparent in the detailed description in which reference is made to the appended drawings wherein:

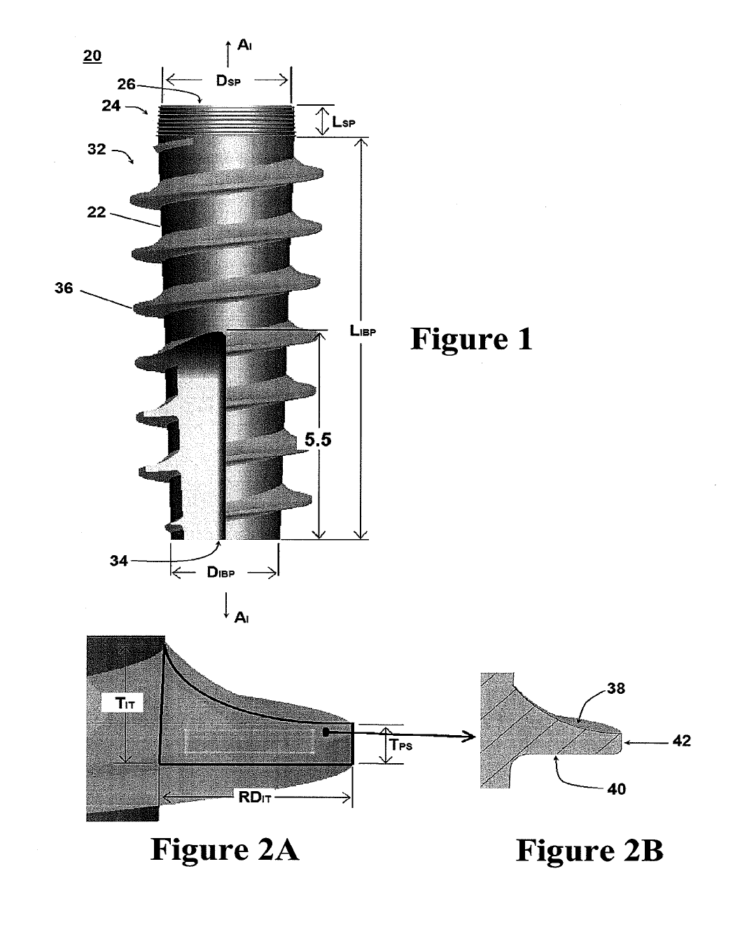

FIG. 1 is a side view of an exemplary implant as described herein.

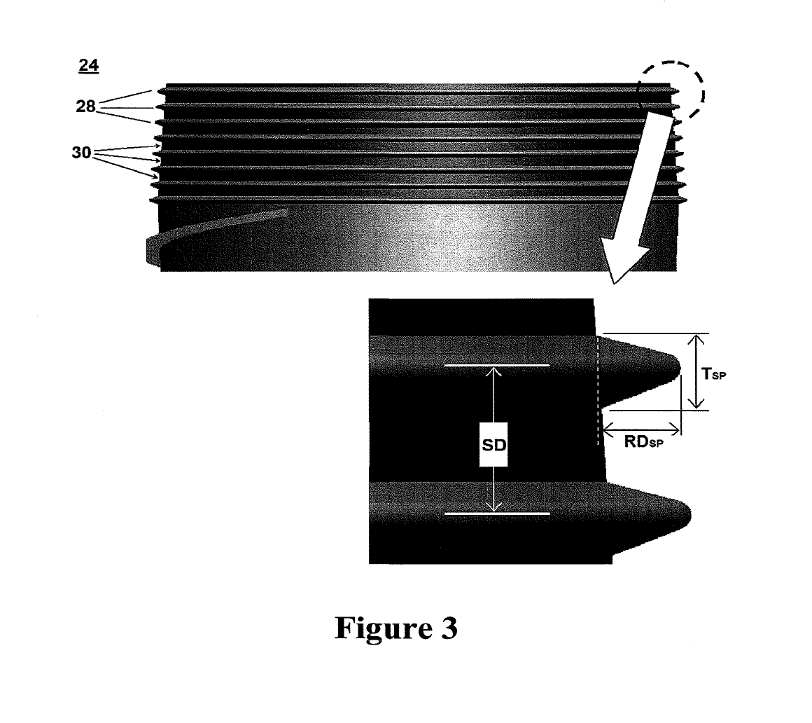

FIG. 2A is an enlarged side perspective view of a helical thread of the implant of FIG. 1, further showing a schematic planar cross-sectional outline view of the helical thread. FIG. 2B is a partial cross-sectional view of the helical thread depicted in FIG. 2A.

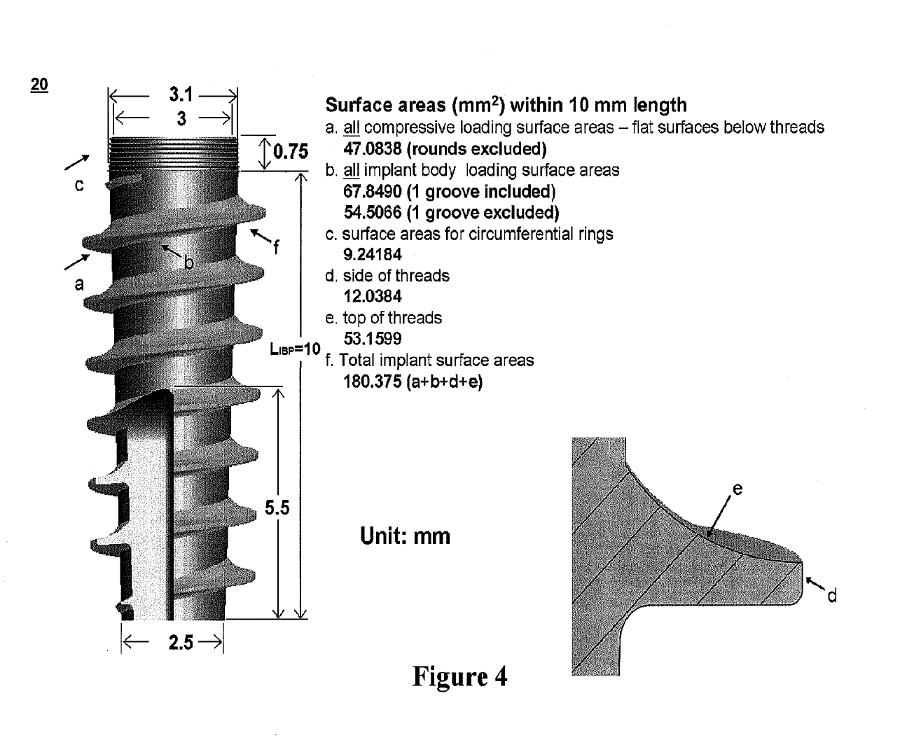

FIG. 3 is an enlarged side view of the shoulder portion of the implant of FIG. 1.

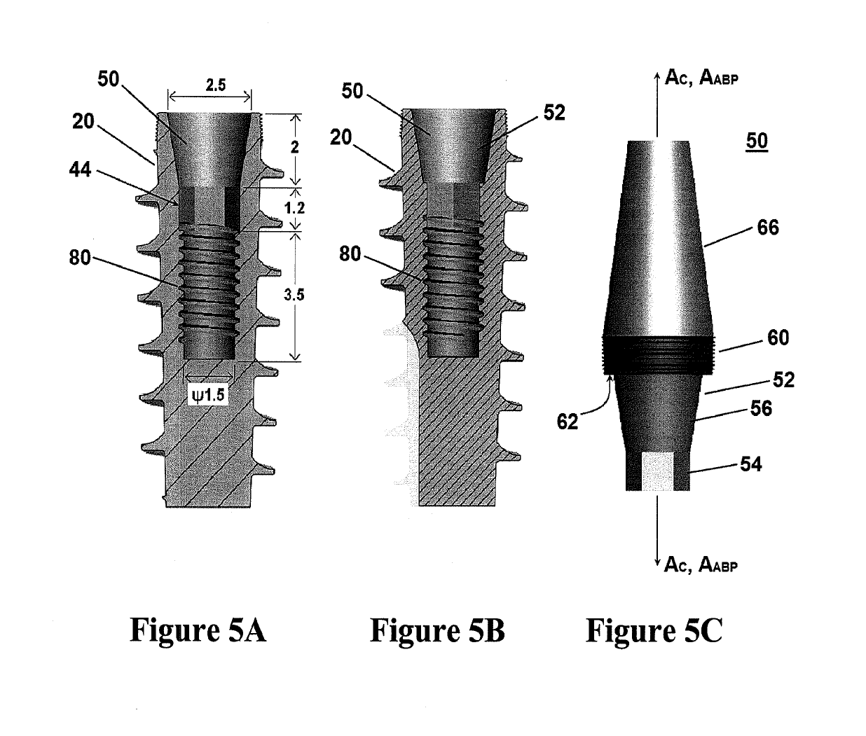

FIG. 4 is a side view of the implant of FIG. 1, including detailed measurements of exemplary surface areas of the various surfaces of the implant.

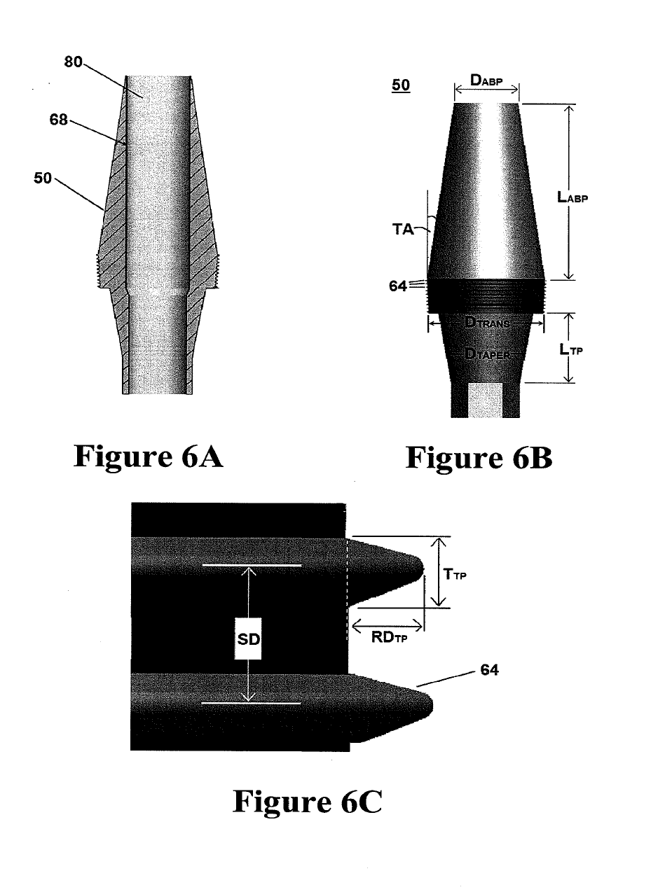

FIGS. 5A and 5B are side cross-sectional views depicting the positioning of an exemplary abutment and abutment screw within the internal cavity of an exemplary implant, as described herein. FIG. 5C is a side view of an exemplary abutment configured for insertion within the internal cavity of the implant, as described herein.

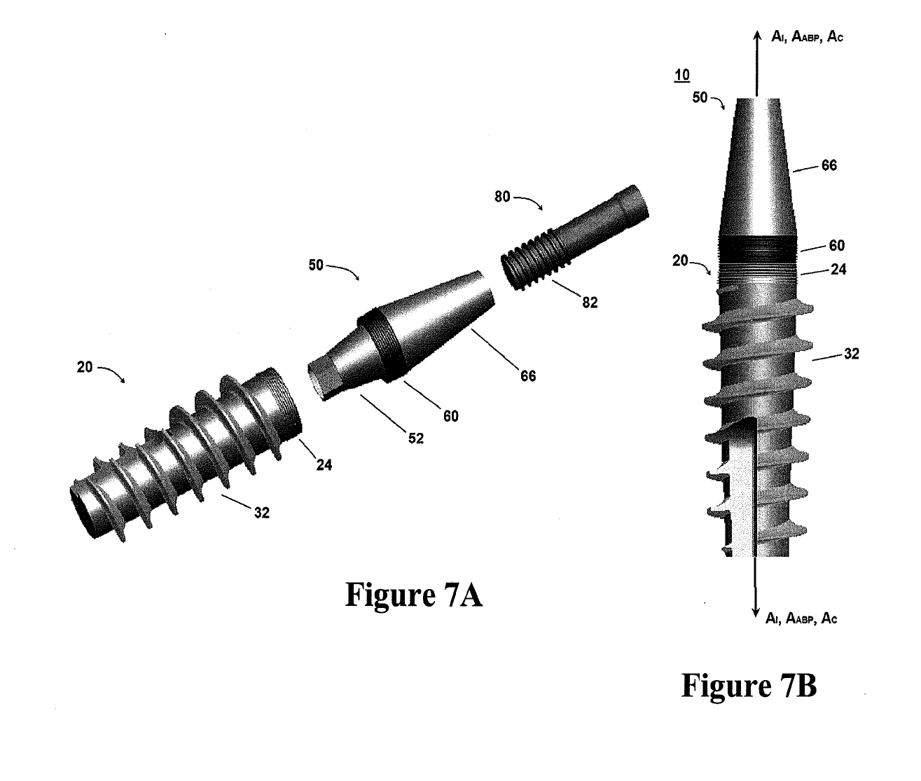

FIG. 6A is a side cross-sectional view of an exemplary abutment, as described herein. FIG. 6B is a side view of the abutment depicted in FIG. 6A.

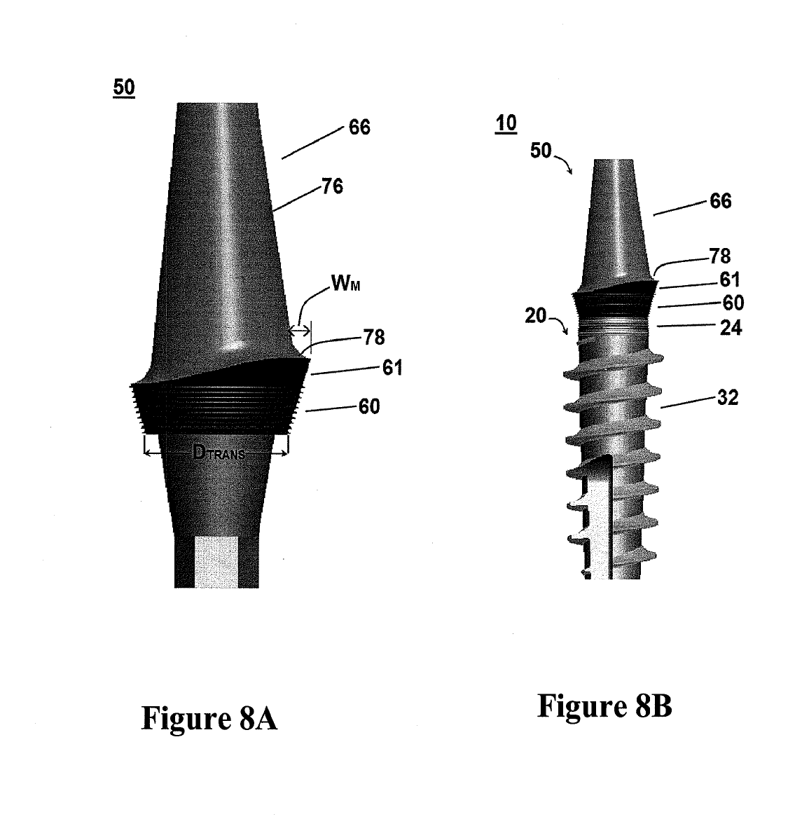

FIG. 7A is an exploded perspective view depicting the assembly of a dental implant system as described herein. FIG. 7B is a side view of the assembled dental implant system depicted in FIG. 7A.

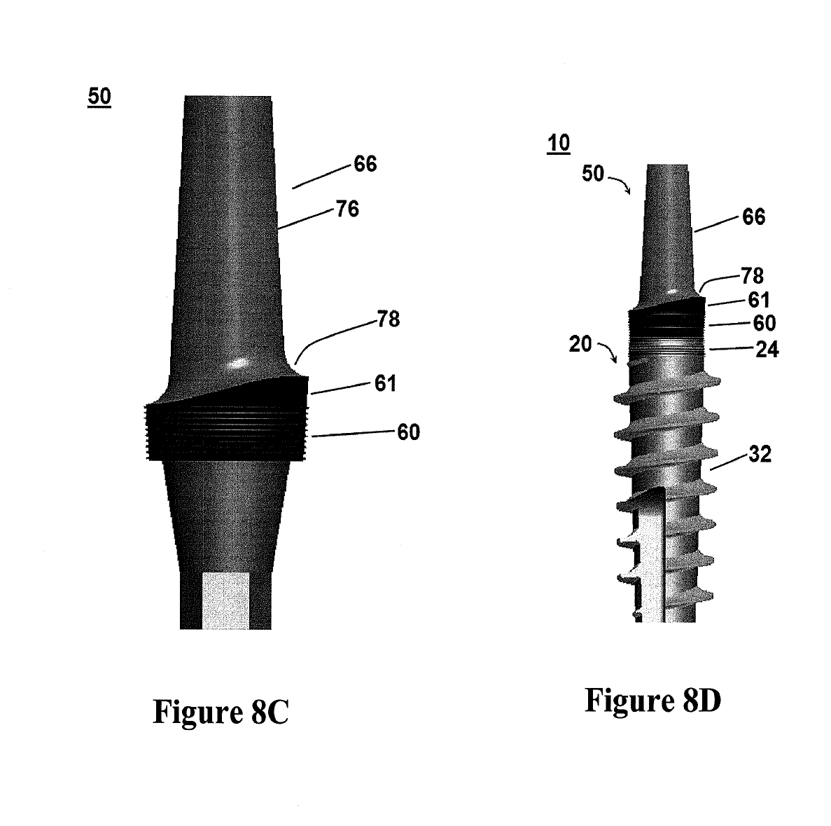

FIG. 8A is a side view of an exemplary straight abutment as described herein. FIG. 8B is a side view of an exemplary dental implant system including the straight abutment depicted in FIG. 8A.

FIG. 8C is a side view of an exemplary straight abutment as described herein. FIG. 8D is a side view of an exemplary dental implant system including the straight abutment depicted in FIG. 8C.

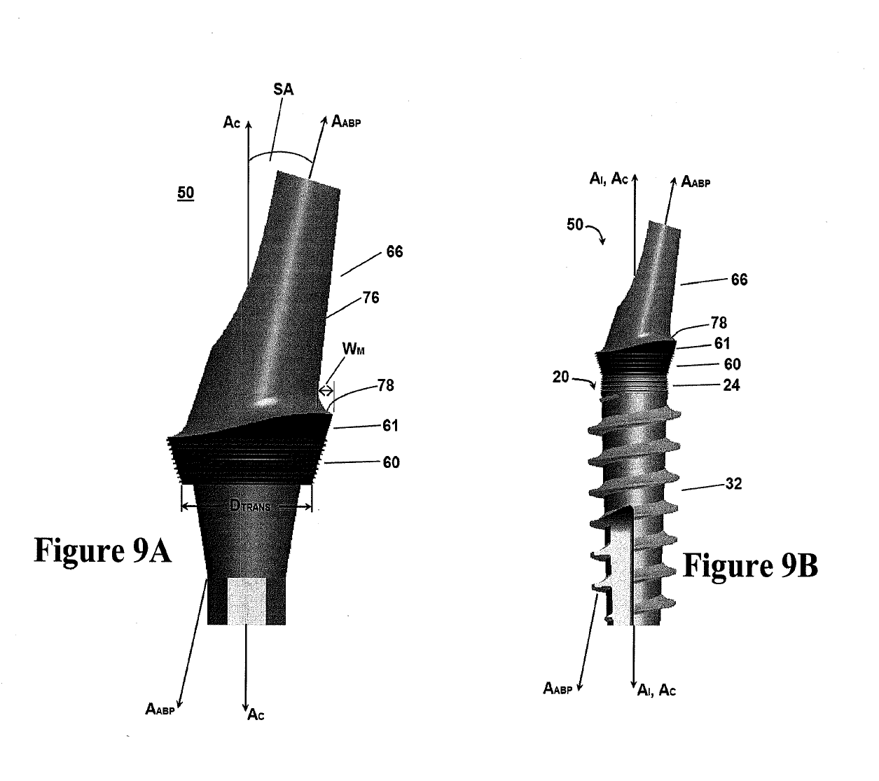

FIG. 9A is a side view of an exemplary angled abutment as described herein. FIG. 9B is a side view of an exemplary dental implant system including the angled abutment depicted in FIG. 9A.

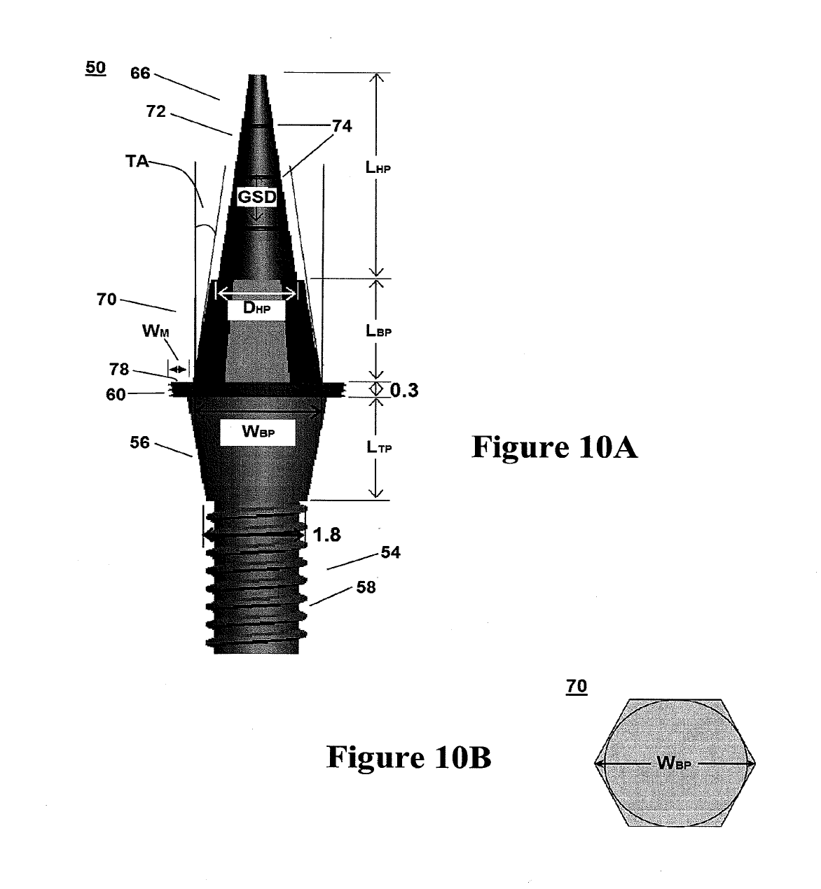

FIG. 10A is a side view of an exemplary provisional abutment as described herein. FIG. 10B is a top view of the base portion of the provisional abutment depicted in FIG. 10A.

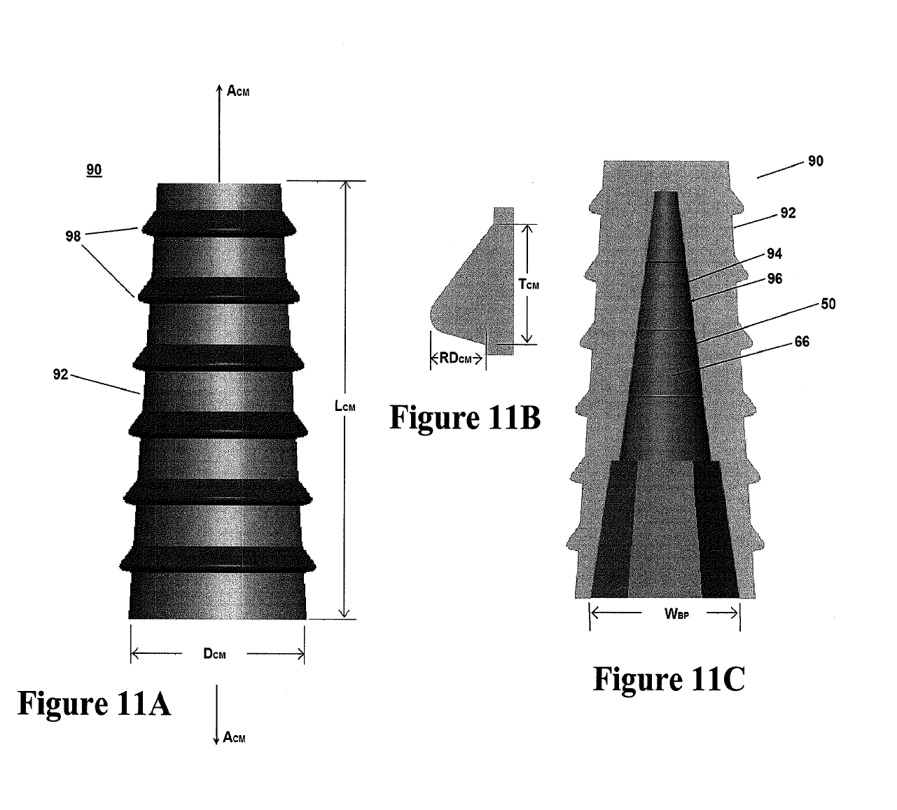

FIG. 11A is a side view of a coping member configured for engagement with the provisional abutment of FIG. 10A. FIG. 11B is a cross-sectional view of a retention ring of the coping member of FIG. 11A. FIG. 11C is a partially transparent side view of the provisional abutment of FIG. 10A positioned within the internal cavity of the coping member depicted in FIG. 11A.

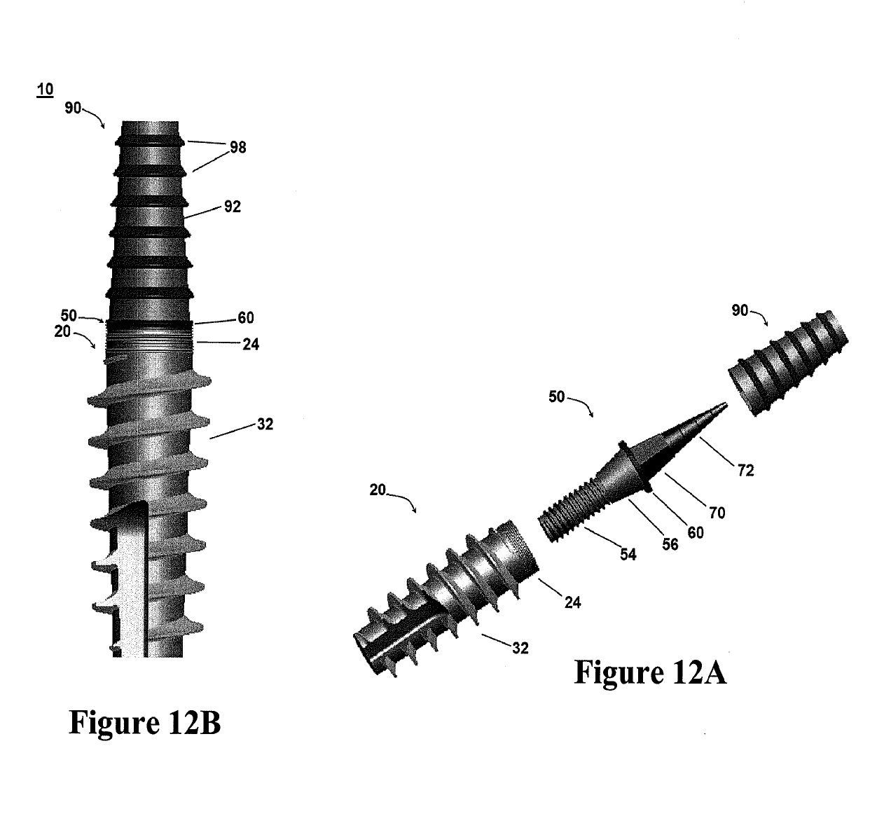

FIG. 12A is a perspective view depicting the assembly of a dental implant system having a coping member as described herein. FIG. 12B is a side view of the assembled dental implant system depicted in FIG. 12A.

Any dimensions indicated on the above-described figures are merely intended to be exemplary dimensions for various elements of the disclosed dental implant system. Thus, as one having ordinary skill in the pertinent art will appreciate, it is contemplated that other suitable dimensions for the various elements of the disclosed dental implant system, such as those dimensions set forth in the following description, can be used within the scope of the invention. Unless otherwise indicated, exemplary dimensions included on the figures are given in millimeters (mm).

### DETAILED DESCRIPTION OF THE INVENTION

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a thread” can include two or more such threads unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

As used herein, the term “apical direction” means a direction toward the roots of a tooth (or a corresponding location on an implant) within the mouth of a subject. As used herein, the term “coronal direction” means a direction toward the crown of a tooth (or a corresponding location on an implant or abutment) within the mouth of a subject. Thus, movement in the apical direction is generally opposite from movement in the coronal direction.

The invention as described herein relates to a dental implant system for securing a dental prosthesis therein a prepared site of a jawbone in a subject. In one embodiment, and with reference to FIGS. 1-12B, the dental implant system 10 can comprise an implant 20 and an abutment 50. In one aspect, as shown in FIG. 1, the implant 20 can have an outer surface 22 and a longitudinal axis A_{I}. In this aspect, the implant 20 can comprise a shoulder portion 24 and an implant body portion 32. In another aspect, the implant 20 can be substantially cylindrical. In a further aspect, the implant 20 can be configured for insertion in the prepared site of the jawbone, and the abutment 50 can be configured for secure attachment to the implant. In this aspect, the abutment 50 can be securely attached to the implant with an abutment screw 80.

In one aspect, and referring to FIGS. 1 and 3, the implant 20 can comprise a shoulder portion 24. In this aspect, the shoulder portion 24 can be tapered in a coronal direction. In this aspect, the shoulder portion 24 can define a coronal end 26 which serves as an attachment junction. It is contemplated that, following placement of the implant 20 in the prepared site, the tapered shape of the shoulder portion 24 can maximize contact with interproximal soft tissue therein the mouth of the subject. It is further contemplated that, following placement of the implant in the prepared site, the tapered shape of the shoulder portion 24 can also maximize space between the implant 20 and adjacent dental prostheses therein the mouth of the subject.

In an additional exemplary aspect and not meant to be limiting, the shoulder portion 24 can have a longitudinal length L_{SP} ranging from about 0.25 mm to about 4.00 mm, more preferably from about 0.40 mm to about 3.00 mm, and most preferably from about 0.50 mm to about 2.00 mm. In a further exemplary non-limiting aspect, the shoulder portion 24 can have a diameter D_{SP} ranging from about 1.00 mm to about 5.00 mm, more preferably from about 2.00 mm to about 4.00 mm, and most preferably from about 2.50 mm to about 3.50 mm. In still another exemplary non-limiting aspect, the diameter D_{SP} of the shoulder portion 24 can consistently increase along the longitudinal axis A_{I} of the implant 20 from the coronal end 26 until reaching the implant body portion 32. In one aspect, the shoulder portion 24 can comprise, for example and without limitation, titanium and other strong metals as are conventionally used in the pertinent art.

In another aspect, and referring to FIG. 3, the shoulder portion 24 can comprise a plurality of spaced circumferential rings 28 which encircle the outer surface 22 of the implant and define a plurality of circumferential grooves 30. In one aspect, each circumferential ring 28 of the plurality of spaced circumferential rings is spaced from adjacent circumferential rings by a separation distance SD along the longitudinal axis A_{I} of the implant. In this aspect, the separation distance SD can correspond to a longitudinal length of each circumferential groove 30 of the plurality of circumferential grooves. It is contemplated that the separation distance SD between adjacent circumferential rings 28, and thus, the longitudinal length of each circumferential groove 30, can range from about 0.01 mm to about 0.25 mm, more preferably from about 0.025 mm to about 0.20 mm, and most preferably from about 0.05 mm to about 0.15 mm. It is further contemplated that the plurality of spaced circumferential rings 28 can comprise between about two circumferential rings and about 20 circumferential rings, more preferably between about 4 circumferential rings and about 16 circumferential rings, and most preferably between about 6 circumferential rings and about 12 circumferential rings. It is contemplated that the circumferential grooves 30 can support the jawbone of the subject while preventing apical migration of soft tissue therein the mouth of the subject.

In an additional aspect, as shown in FIG. 3, each circumferential ring 28 of the plurality of spaced circumferential rings can have a radial depth RD_{SP} which corresponds to the distance by which each circumferential ring extends radially from the outer surface 22 of the implant 20. In this aspect, it is contemplated that the radial depth RD_{SP} of each circumferential ring 28 can range from about 0.01 mm to about 0.15 mm, more preferably from about 0.02 mm to about 0.1 mm, and most preferably from about 0.03 mm to about 0.07 mm. In an additional aspect, each circumferential ring 28 of the plurality of spaced circumferential rings can have a longitudinal thickness T_{SP} measured along the longitudinal axis A_{I} of the implant 20. In this aspect, it is contemplated that the longitudinal thickness T_{SP} of each circumferential ring 28 can range from about 0.01 mm and 0.15 mm, more preferably between about 0.02 mm and 0.1 mm, and most preferably between about 0.03 mm and 0.07 mm. In a further aspect, each circumferential ring 28 of the plurality of circumferential rings can be substantially beveled.

In another aspect, and referring to FIGS. 1 and 2A-2B, the implant 20 can comprise an implant body portion 32 that defines an apical end 34. In one aspect, the implant body portion 32 can have a diameter D_{IBP} and a longitudinal length L_{IBP}. In this aspect, it is contemplated that the diameter D_{IBP} of the implant body portion 32 can range from about 1.00 mm to about 5.00 mm, more preferably from about 1.50 mm to about 4.00 mm, and most preferably between about 2.00 mm and 3.50 mm. It is further contemplated that the longitudinal length L_{IBP} of the implant body portion 32 can range from about 6.00 mm to about 14.00 mm, more preferably from about 7.00 mm to about 13.00 mm, and most preferably from about 8.00 mm to about 12.00 mm. In another aspect, the implant body portion 32 can be tapered in an apical direction. In this aspect, the diameter D_{IBP} of the implant body portion 32 can consistently decrease along the longitudinal axis A_{I} of the implant 20 until reaching the apical end 34 of the implant 20.

In one aspect, the apical end 34 of the implant 20 can be substantially flat. In this aspect, the apical end 34 can be oriented substantially perpendicularly to the longitudinal axis A_{I} of the implant 20. It is contemplated that the flat profile of the apical end 34 can permit full seating of the implant 20 during surgical insertion into the jawbone of the subject. It is further contemplated that, following implantation of the implant 20, the flat profile of the apical end 34 will permit the entire surface of the apical end to contact the jawbone, thereby promoting maximal force transfer during functional loading.

In an additional aspect, and referring to FIGS. 1 and 2A-2B, the implant body portion 32 can comprise an implant thread 36 positioned thereon the outer surface 22 of the implant 20. In this aspect, the implant thread 36 can substantially helically extend along at least a portion of the length L_{IBP} of the implant body portion 32. In one exemplary aspect, the implant thread 36 can begin proximate the shoulder portion 24 and substantially helically extend around the implant body portion 32 until terminating proximate the apical end 34 of the implant 20. In one aspect, the implant thread 36 can be a modified reverse buttress thread. In this aspect, it is contemplated that the implant thread 36 can be a deep thread that is configured to permit self-tapping of the implant 20 into the jawbone of the subject.

In another aspect, and with reference to FIGS. 2A-2B, the implant thread 36 can have an upper loading surface 38, a lower loading surface 40, and a pitch surface 42 positioned therebetween and connected thereto the upper and lower loading surfaces. In this aspect, the upper loading surface 38 can be concavely curved, while the lower loading surface 40 can extend substantially perpendicularly to the longitudinal axis A_{I} of the implant 20. It is contemplated that the lower loading surface 40 can be configured to transfer and distribute occlusal loads following implantation. It is further contemplated that the orientation of the lower loading surface 40 can maximize the area available for implant-to-bone biomechanical compressive stress transfer. In an additional aspect, the implant thread 36 can have a radial depth RD_{IT} ranging from about 0.40 mm to about 1.00 mm, more preferably from about 0.50 mm to about 0.90 mm, and most preferably from about 0.60 mm to about 0.80 mm.

In a further aspect, at a selected cross-section of the implant thread 36, the implant thread can have a thickness T_{IT} corresponding to the area of contact between the implant thread and the implant body portion 32 along the longitudinal axis A_{I} of the implant 20. In this aspect, the thickness T_{IT} of the implant thread 36 can be from about 0.25 mm to about 0.75 mm, more preferably from about 0.35 mm to about 0.65 mm, and most preferably from about 0.40 mm to about 0.60 mm. In an additional aspect, it is contemplated that, at a particular position thereon a surface of the implant thread 36, the ratio of the thickness T_{IT} of the implant thread to the radial depth RD_{IT} of the implant thread can provide desired rigidity for improving force transfer from an inner portion of the thread proximate the outer surface 22 of the implant 20 to the pitch surface 42, as well as force transfer along the length L_{IBP} of the implant body portion 32. In still a further aspect, the pitch surface 42 can extend substantially parallel to the longitudinal axis A_{I} of the implant 20. In this aspect, the pitch surface 42 can have a thickness T_{PS} ranging from about 0.025 mm to about 0.30 mm, more preferably from about 0.05 mm to about 0.25 mm, and most preferably from about 0.10 mm to about 0.20 mm.

In one aspect, the implant thread 36 can be configured to have a thread pitch corresponding to the distance by which the implant thread can be advanced per 360 degree rotation of the implant 20. In this aspect, the thread pitch can range from about 1.00 mm to about 2.00 mm, more preferably from about 1.10 mm to about 1.75 mm, and most preferably from about 1.20 mm to about 1.50 mm. It is contemplated that the configuration of the implant thread 36 can reduce the shear loading at the thread-bone interface, thereby providing more compressive load transfer. It is further contemplated that the implant thread 36 can have sufficient surface area to dissipate loads and provide stability to the implant 20 following implantation. It is still further contemplated that the implant thread 36 can provide stability to the implant 20 in as little as 3 mm of bone in an immediate extraction site. It is still further contemplated that the implant thread pattern can be a widely spaced pattern configured to permit formation and maintenance of haversion bone therebetween portions of the implant thread 36.

In a further aspect, the various surfaces of the implant 20, including without limitation, the shoulder portion 24, the outer surface 22 of the implant, and the implant thread 36, can be microtextured. In one aspect, the various surfaces of the implant 20 can be nanotextured. It is contemplated that the micro- or nano-texturing of the various surfaces of the implant 20 can significantly increase the surface area of the implant 20, thereby creating a micro- or nano-scopic surface of peaks and valleys configured to function as teeth on a saw. It is further contemplated that the surface area of the implant 20 can be increased by about 20% to about 40% relative to conventional dental implants by the selective texturing of select portion of the implant 20. It is still further contemplated that the texturing of the surfaces of the implant 20 can be configured to disrupt the adherence and colonization of bacterial biofilms, thereby limiting the potential for infection. It is still further contemplated that the texturing of the surfaces of the implant 20 can also be configured to enhance the adherence of osteoblast bone-forming cells, thereby improving osseointegration, accelerating the wound healing process, and increasing the lifespan of the implant.

In another aspect, it is contemplated that micro-texturing of surfaces of the implant 20 can produce a plurality of indentations which extend inwardly from the surfaces of the implant by about 0.01 to about 0.20 mm. In one aspect, the indentations of the micro-textured surfaces can extend inwardly from the surfaces of the implant 20 by about 0.05 mm. It is further contemplated that the micro-textured surfaces of the implant 20 can be superimposed with nano-texturing. In one aspect, it is contemplated that nano-texturing of the micro-textured implant surfaces can produce a plurality of indentations which extend inwardly from the micro-textured surfaces by about 0.0001 mm to about 0.000005 mm. In this aspect, the indentations of the nano-textured surfaces can extend inwardly from the micro-textured surfaces by about 0.00002 mm.

In an additional aspect, it is contemplated that the plurality of indentations of the micro-textured surfaces can be formed using various conventional techniques. In one aspect, the plurality of indentations of the micro-textured surfaces can be formed using high-velocity particle stream processing (blasting). In this aspect, the particle stream can comprise, for example and without limitation, calcium phosphates, calcium sulfates, calcium carbonates, and the like. It is contemplated that, following the blasting of the surfaces of the implant in this manner, the micro-textured surface can be treated with an acidic solution to reproduce a thin amorphous metal oxide, for example and without limitation, an amorphous titanium oxide. In a further aspect, it is contemplated that the plurality of indentations of the nano-textured surfaces can be formed by employing various conventional techniques. In one aspect, the plurality of indentations of the nano-textured surfaces can be formed by an electrochemical process. In this aspect, it is contemplated that the implant surfaces can be maintained at an anodic overvoltage potential in an acidic solution. It is further contemplated that nano-scale finishing can be applied to the implant surfaces, thereby creating nano-dimensioned indentations in the amorphous metal oxide of the implant surfaces.

In another aspect, and referring to FIGS. 5A-5C, the implant 20 can comprise an internal cavity 44 defined therein the coronal end 26 of the implant and extending along the longitudinal axis A_{I} of the implant therethrough the shoulder portion 24 and at least a portion of the implant body portion 32. In this aspect, the internal cavity 44 of the implant 20 can be configured to receive at least a portion of the abutment 50. In one aspect, and referring to FIGS. 10A and 12A-12B, at least a portion of the abutment 50 can be threaded. In this aspect, the internal cavity 44 can be configured to receive the threaded portion of the abutment 50. In a further aspect, with reference to FIGS. 5A and 7B, the internal cavity 44 can be configured to receive the abutment screw 80.

In one aspect, and referring to FIGS. 5C and 6B, the abutment 50 can comprise a connector portion 52 configured for selective secure attachment therein the internal cavity 44 of the implant 20. In one aspect, the connector portion 52 can comprise an insertion end 54 and a tapered portion 56 having a variable diameter D_{TAPER}. In this aspect, the insertion end 54 can be substantially hexagonal. It is contemplated that the hexagonal shape of the insertion end 54 can provide resistance to rotation and off-axis bending of the abutment 50 therein the internal cavity 44 of the implant 20.

As depicted in FIGS. 5A-6C, the tapered portion 56 can be configured such that the diameter D_{TAPER} of the tapered portion 56 increases in a coronal direction. In another aspect, the tapered portion 56 can have a longitudinal length L_{TP} ranging from about 1.00 mm to about 3.00 mm, and more preferably about 2.00 mm. Optionally, in an additional aspect, the insertion end 54 can comprise a threaded portion 58. In this aspect, the threaded portion 58 of the insertion end 54 can have a maximum diameter ranging from about 1.00 mm to about 2.50 mm, and more preferably being about 1.80 mm. It is contemplated that the connector portion 52 can be configured to prevent leakage of tissue and/or intraoral fluids following secure attachment of the connector portion within the internal cavity 44 of the implant 20.

In another aspect, the abutment 50 can comprise a transition portion 60 configured to abut the shoulder portion 24 of the implant 20. In this aspect, the connector portion 52 can terminate into the transition portion 60. In one aspect, the connector portion 52 and the transition portion 60 can have a common longitudinal axis A_{C}. In an additional aspect, the transition portion 60 can have a circumference. In another aspect, the transition portion 60 can have a diameter D_{TRANS} that is greater than the diameter D_{TAPER} of the tapered portion 56 of connector portion 52. In this aspect, the diameter D_{TRANS} of the transition portion 60 can be substantially equal to the diameter D_{SP} of the shoulder portion 24 of the implant 20.

Optionally, the transition portion 60 can be tapered such that the diameter D_{TRANS} of the transition portion 60 increases in a coronal direction. As depicted in FIG. 5C, it is contemplated that the increased diameter of the transition portion 60 relative to the connector portion 52 can create an abutment surface 62 where the shoulder portion 24 of the implant 20 substantially aligns with the transition portion. As shown in FIGS. 5C, 7B, and 9B, it is further contemplated that, upon attachment of the connector portion 52 of the abutment 50 therein the internal cavity 44 of the implant 20, the common longitudinal axis A_{C} of the connector portion and the transition portion 60 of the abutment can be substantially aligned with the longitudinal axis A_{I} of the implant.

In another aspect, with reference to FIG. 6C, the transition portion 60 can comprise a plurality of spaced circumferential rings 64 which encircle an outer surface of the transition portion and define a plurality of circumferential grooves. In this aspect, it is contemplated that the plurality of circumferential rings 64 of the transition portion 60 can be substantially identical to the circumferential rings 28 of the shoulder portion 24 of the implant 20, thereby forming a continuous series of circumferential rings following attachment of the abutment 50 to the implant. Thus, in one aspect, each circumferential ring 64 of the transition portion 60 can be spaced from adjacent circumferential rings by a separation distance SD along the longitudinal axis A_{C} of the transition portion. In this aspect, the separation distance SD can correspond to a longitudinal length of each circumferential groove of the transition portion 60. It is contemplated that the separation distance SD between adjacent circumferential rings 64, and thus, the longitudinal length of each circumferential groove, can range from about 0.01 mm to about 0.25 mm, more preferably from about 0.025 mm to about 0.20 mm, and most preferably from about 0.05 mm to about 0.15 mm. It is further contemplated that the plurality of spaced circumferential rings 64 of the transition portion 60 can comprise between about two circumferential rings and about 20 circumferential rings, more preferably between about 4 circumferential rings and about 16 circumferential rings, and most preferably between about 6 circumferential rings and about 12 circumferential rings.

In a further aspect, it is contemplated that each circumferential ring 64 of the transition portion 60 can have a radial depth RD_{TP} which corresponds to the distance by which each circumferential ring extends radially from the outer surface of the transition portion. In this aspect, it is contemplated that the radial depth RD_{TP} of each circumferential ring 64 can range from about 0.01 mm to about 0.15 mm, more preferably from about 0.02 mm to about 0.1 mm, and most preferably from about 0.03 mm to about 0.07 mm. In an additional aspect, each circumferential ring 64 of the transition portion 60 can have a longitudinal thickness T_{TP} measured along the longitudinal axis A_{C} of the transition portion. In this aspect, it is contemplated that the longitudinal thickness T_{TP} of each circumferential ring 64 can range from about 0.01 mm and 0.15 mm, more preferably between about 0.02 mm and 0.1 mm, and most preferably between about 0.03 mm and 0.07 mm. In a further aspect, each circumferential ring 64 of the transition portion 60 can be substantially beveled.

It is contemplated that the tapered shape of the connection portion 52 can create a low contact angle connection, and the connection portion can cooperate with the abutment surface 62 to form a tight seal between the implant 20 and the abutment 50. As shown in FIG. 6B, in one aspect, the transition portion 60 can have a longitudinal length L_{TP} ranging from about 0.50 mm to about 1.50 mm, and more preferably being about 1.00 mm.

In an additional aspect, and referring to FIGS. 5C and 7A-8D, the abutment 50 can comprise an abutment body portion 66 positioned adjacent the transition portion 60. In one aspect, the abutment body portion 66 can have a longitudinal axis A_{ABP}. In another aspect, the abutment body portion 66 can be tapered in a coronal direction. In this aspect, the abutment body portion 66 can have a variable diameter D_{ABP} that decreases as the abutment body portion extends away from the transition portion 60 along the longitudinal axis A_{ABP} of the abutment body portion. It is contemplated that the diameter D_{ABP} of the abutment body portion 66 can have a maximum diameter ranging from about 2.00 mm to about 5.00 mm, more preferably from about 2.25 mm to about 4.75 mm, and most preferably from about 2.50 mm to about 4.50 mm. In another aspect, the abutment body portion 66 can have a longitudinal length L_{ABP} ranging from about 3.00 mm to about 7.00 mm, more preferably from about 3.50 mm to about 6.50 mm, and most preferably from about 4.00 mm to about 6.00 mm. In a further aspect, the abutment body portion 66 can be tapered at a taper angle TA relative to the longitudinal axis A_{ABP} of the abutment body portion. In this aspect, the taper angle TA can range from about 1 degree to about 15 degrees, more preferably from about 2 degrees to about 12 degrees, and most preferably from about 2.5 degrees to about 10 degrees.

Optionally, as shown in FIG. 6A, the abutment 50 can comprise an internal bore 68 extending along the entire longitudinal length of the abutment—through the abutment body portion 66, the transition portion 60, and the connector portion 52. In one aspect, the internal bore 68 of the abutment 50 can be configured to receive the abutment screw 80. In this aspect, the abutment screw 80 can be configured for receipt within the internal bore 68 of the abutment 50 and within a portion of the internal cavity 44 of the implant 20. In one exemplary aspect, the abutment screw 80 can comprise a threaded portion 82. In another aspect, the abutment 50 can comprise means for securing the screw 80 therein the internal bore 68 of the abutment such that the threaded portion 82 of the abutment screw 80 is positioned beyond the insertion end 54 of the abutment.

In one exemplary embodiment, and with reference to FIGS. 10A and 12A-12B, the abutment body portion 66 can comprise a base portion 70 and a head portion 72. In one aspect, the base portion 70 can be positioned therebetween the transition portion 60 and the head portion 72 along the longitudinal axis A_{ABP} of the abutment body portion 66. In another aspect, as shown in FIG. 10B, the base portion 70 can have a substantially hexagonal cross-sectional profile. In still another aspect, the head portion 72 can be substantially conical. In a further aspect, the head portion 72 can comprise a plurality of spaced grooves 74 defined therein the outer surface of the abutment 50. In this aspect, the grooves 74 of the head portion 72 can be spaced from one another by a groove separation distance GSD. In one exemplary aspect, the groove separation distance GSD can be about 1.00 mm. In an additional aspect, the base portion 70 can have a width W_{BP}. In this aspect, the maximum width of the base portion 70 can range from about 1.00 mm to about 3.50 mm, more preferably from about 1.50 mm to about 3.00 mm, and most preferably from about 2.00 mm to about 2.50 mm. In another aspect, the minimum width of the base portion 70 can range from about 1.00 mm to about 2.50 mm. In an additional aspect, it is contemplated that the base portion 70 can have a longitudinal length L_{BP} ranging from about 1.00 mm to about 3.00 mm, and more preferably being about 2.00 mm. In a further aspect, it is contemplated that the head portion can have a longitudinal length L_{HP} ranging from about 2.00 mm to about 6.00 mm, more preferably from about 3.00 mm to about 5.00 mm, and most preferably from about 3.50 mm to about 4.50 mm. In still a further aspect, the plurality of spaced grooves 74 can comprise three spaced grooves. In this aspect, it is contemplated that the grooves 74 of the plurality of spaced grooves can be spaced from adjacent grooves by about 1.00 mm. In another aspect, it is contemplated that the head portion 72 can have a diameter D_{HP}. In this aspect, it is contemplated that the maximum diameter of the head portion 72 can range from about 0.50 mm to about 2.50 mm, and more preferably from about 1.00 mm to about 2.00 mm. In this aspect, it is contemplated that the maximum diameter of the head portion 72 can be less than the minimum width of the base portion 70.

Optionally, in one aspect, as shown in FIGS. 6B and 8A-10A, the longitudinal length L_{TP} of the transition portion 60 can be variable along the circumference of the transition portion. In this aspect, the transition portion 60 can comprise a lip portion 61. In one aspect, the lip portion 61 can have a smooth outer surface.

In a further aspect, and with reference to FIGS. 8A-10A, the abutment body portion 66 can comprise an outer surface 76 having a margin 78 proximate the transition portion 60 of the abutment 50. In this aspect, the margin 78 can terminate into the transition portion 60. For example, as shown in FIGS. 8A-9, where the transition portion 60 has a lip portion 61, the margin 78 can terminate into the lip portion 61. In one aspect, the margin 78 can have a radial width W_{M}. In this aspect, the radial width W_{M} can range from about 0.10 mm to about 1.00 mm, more preferably from about 0.20 mm to about 0.80 mm, and most preferably from about 0.30 mm to about 0.50 mm. In an additional aspect, the margin 78 can be substantially curved.

In still a further aspect, and with reference to FIGS. 9A-9B, the longitudinal axis A_{ABP} of the abutment body portion 66 can be angled at a selected angle SA relative to the common longitudinal axis A_{C} of the connection portion 52 and the transition portion 60 of the abutment 50. In this aspect, the selected angle SA can range from about 0 degrees to about 30 degrees, more preferably between about 5 degrees and 25 degrees, and most preferably between about 10 degrees and about 20 degrees.

In another aspect, and with reference to FIGS. 10A-12B, the abutment 50 can be a provisional abutment. In this aspect, the abutment 50 can be configured to engage a coping member 90. In one aspect, the coping member 90 can be substantially cylindrical, having a longitudinal axis A_{CM} and a circumference. In still another aspect, the coping member 90 have an outer surface 92 and an inner surface 94. In this aspect, the inner surface 94 of the coping member 90 can define an internal cavity 96 configured to receive at least a portion of the abutment body portion 66. In an additional aspect, the coping member 90 can have a longitudinal length L_{CM} ranging from about 5.00 mm to about 8.00 mm, more preferably from about 5.50 mm to about 7.50 mm, and most preferably from about 6.00 mm to about 7.00 mm. In a further aspect, the coping member 90 can have a diameter D_{CM}. In this aspect, the maximum outer diameter of the coping member 90 can range from about 2.00 mm to about 4.00 mm, and more preferably be about 3.00 mm. In another aspect, the coping member 90 can be tapered relative to the longitudinal axis A_{ABP} of the abutment body portion 66 such that the diameter D_{CM} of the coping member varies. In still a further aspect, the coping member can comprise a plurality of retention rings 98 secured around the circumference of the coping member 90 and extending radially therefrom the outer surface 92 of the coping member. In this aspect, each retention ring 98 of the plurality of retention rings can have a radial depth RD_{CM} ranging from about 0.10 to about 0.30 mm, and more preferably about 0.20 mm. It is further contemplated that each retention ring 98 of the plurality of retention rings can have a longitudinal thickness T_{CM} ranging from about 0.20 mm to about 0.60 mm, and more preferably being about 0.40 mm.

In exemplary aspects, it is contemplated that elements of the connector portion, the transition portion, and the abutment body portion can be micro- or nano-textured as described herein with respect to the implant.

In use, and referring to FIGS. 7A-7B, a method for securing a dental prosthesis therein a prepared site of a jawbone in a subject is provided. In one aspect, the method for securing a dental prosthesis can comprise providing an implant, an abutment, and an abutment screw as described herein. In another aspect, the method can comprise positioning the implant body portion therein the prepared site of the jawbone. In an additional aspect, the method can comprise securely attaching at least a portion of the abutment therein the internal cavity of the implant. In this aspect, the step of positioning at least a portion of the abutment therein the internal cavity of the implant can comprise securely attaching the connector portion of the abutment therein the internal cavity of the implant. It is contemplated that the connector portion can be securely attached therein the internal cavity of the implant such that the common longitudinal axis of the connector portion and the transition portion is substantially axially aligned with the longitudinal axis of the implant and the transition portion of abutment abuts the shoulder portion of the implant. In a further aspect, the method can comprise inserting the abutment screw therein the internal bore of the abutment such that the threaded portion of the abutment screw is positioned therein the internal cavity of the implant. In still a further aspect, the method can comprise securing a portion of the abutment screw therein the internal cavity of the implant. In this aspect, the step of securing a portion of the abutment screw therein the internal cavity of the implant can comprise directing a threaded portion of the abutment screw through the internal bore of the abutment and securing at least a portion of the threaded portion of the abutment screw therein the internal cavity of the implant. It is contemplated that, following the step of securing the threaded portion of the abutment screw therein the internal cavity of the implant, a non-threaded portion of the abutment screw can be securely positioned within the internal bore of the abutment. It is further contemplated that the abutment screw can be secured by rotation of the abutment screw using dental instruments, including, for example and without limitation, a dental drill. In an additional aspect, the method can comprise securing the dental prosthesis thereto at least a portion of the abutment using conventional mechanisms.

Optionally, and referring to FIGS. 12A-12B, the method for securing a dental prosthesis therein a prepared site of a jawbone in a subject can comprise providing an implant, abutment, and coping member as described herein. In another aspect, the method can comprise positioning the implant body portion therein the prepared site of the jawbone. In an additional aspect, the method can comprise securely attaching at least a portion of the abutment therein the internal cavity of the implant. In this aspect, the step of securely attaching at least a portion of the abutment therein the internal cavity of the implant can comprise securely attaching the connector portion of the abutment therein the internal cavity of the implant. It is contemplated that the connector portion can be securely attached therein the internal cavity of the implant such that the common longitudinal axis of the connector portion and the transition portion is substantially axially aligned with the longitudinal axis of the implant and the transition portion of abutment abuts the shoulder portion of the implant. In a further aspect, the method can comprise attaching the coping member thereto the abutment such that the abutment body portion is received therein the internal cavity of the coping member. In an additional aspect, the method can comprise securing the dental prosthesis thereto at least a portion of the coping member using conventional mechanisms.

### Experimental Examples

In one exemplary embodiment, as depicted in FIG. 4, the longitudinal length of the implant body portion can be constructed to be 10.0 mm. In this embodiment, the longitudinal length of the shoulder portion can be constructed to be 0.75 mm. As depicted, the diameter of the shoulder portion can be constructed to be 3.00 mm proximate the coronal end of the implant and 3.10 mm proximate the implant body portion. The diameter of the implant body portion tapers from 3.10 mm proximate the shoulder portion to 2.50 mm proximate the apical end of the implant. In this embodiment, the total surface area of the implant body portion, excluding the implant thread, was calculated to be 67.8490 mm² (including all spaces between the implant thread) and 54.5066 mm² (excluding one groove defined by the implant thread). The total surface area of the lower loading surfaces of the implant thread was calculated to be 47.0838 mm², while the total surface area of the upper loading surfaces of the implant thread was calculated to be 53.1599 mm². The surface areas of the plurality of circumferential rings were calculated to total 9.24184 mm². The total surface area of the pitch surface of the implant thread was calculated to be 12.0384 mm². Finally, in this exemplary embodiment, the total surface area of the implant body portion, including the surface areas of the implant thread, was calculated to be 180.375 mm².

In one simulated experiment, the exemplary embodiment of the implant as depicted in FIGS. 1 and 4 was coupled to the straight abutment depicted in FIGS. 5-7. In the experimental model, the dental implant system was secured therein the prepared site of a subject's jawbone and subjected to a 100 N load. In response to this loading, the dental implant system experienced a stress of 103 MPa. The jawbone of the subject exhibited a stress of 26 MPa and a strain of 3,179. In this experiment, the greatest strain occurred proximate the junction between the abutment and implant.

In a second simulated experiment, the exemplary embodiment of the implant as depicted in FIGS. 1 and 4 was coupled to the angled abutment as depicted in FIG. 9. In response to 100 N loading, this dental implant system experienced a stress of 143 MPa. The jawbone of the subject exhibited a stress of 45 MPa and a strain of 1,898. As one having ordinary skill in the pertinent art will appreciate, because a bone strain of around 4,000 can cause crestal bone loss, both experimentally tested embodiments of the dental implant system exhibit ideal bone strain properties.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A dental implant system for securing a dental prosthesis therein a prepared site of a jawbone, the dental implant system comprising:
an implant having a longitudinal axis, the implant comprising:
a shoulder portion defining a coronal end of the implant and comprising a plurality of spaced circumferential rings;
a implant body portion defining an apical end of the implant and having a longitudinal length and an implant thread, the implant thread substantially helically extending along at least a portion of the length of the implant body portion, wherein the implant body portion is tapered in an apical direction; and
an internal cavity defined therein the coronal end of the implant and extending along the longitudinal axis of the implant therethrough the shoulder portion and at least a portion of the implant body portion; and
an abutment comprising:
a connector portion configured for selective secure attachment therein the internal cavity of the implant;
a transition portion configured to abut the shoulder portion of the implant, the transition portion comprising a plurality of spaced circumferential rings, wherein the connector portion and the transition portion have a common longitudinal axis; and
an abutment body portion, wherein the abutment body portion is tapered in a coronal direction,
wherein, upon attachment of the connector portion of the abutment therein the internal cavity of the implant, the common longitudinal axis of the connector portion and the transition portion of the abutment is substantially axially aligned with the longitudinal axis of the implant.

2. The dental implant system of claim 1, wherein the abutment has a longitudinal length, wherein the abutment defines an internal bore extending along the entire length of the abutment, and wherein the dental implant system further comprises an abutment screw configured for receipt within the internal bore of the abutment and within a portion of the internal cavity of the implant.

3. The dental implant system of claim 1, wherein each circumferential ring of the shoulder portion is spaced from adjacent circumferential rings by a separation distance along the longitudinal axis of the implant, and wherein the separation distance ranges from about 0.01 mm to about 0.25 mm.

4. The dental implant system of claim 1, wherein each circumferential ring of the shoulder portion has a radial depth and a longitudinal thickness, and wherein the radial depth and the longitudinal thickness of each circumferential ring range from about 0.01 mm to about 0.15 mm.

5. The dental implant system of claim 1, wherein the longitudinal length of the body portion of the implant ranges from about 6.00 mm to about 14.00 mm.

6. The dental implant system of claim 1, wherein apical end of the implant is substantially flat, and wherein the apical end of the implant is oriented substantially perpendicularly to the longitudinal axis of the implant.

7. The dental implant system of claim 1, wherein the implant thread of the implant body portion substantially helically extends from proximate the shoulder portion of the implant to proximate the apical end of the implant.

8. The dental implant system of claim 1, wherein the implant thread of the implant body portion has an upper loading surface, a lower loading surface, and a pitch surface positioned therebetween and connected thereto the upper and lower loading surfaces.

9. The dental implant system of claim 8, wherein the implant thread has a radial depth ranging from about 0.40 mm to about 1.00 mm, wherein the implant thread has a thickness ranging from about 0.25 mm to about 0.75 mm, and wherein the pitch surface has a thickness ranging from about 0.025 mm to about 0.30 mm.

10. The dental implant system of claim 9, wherein the implant thread of the implant body portion has a thread pitch ranging from about 1.00 mm to about 2.00 mm.

11. The dental implant system of claim 1, wherein at least a portion of the implant is micro-textured.

12. The dental implant system of claim 11, wherein the micro-textured portion of the implant is superimposed with nano-texturing.

13. The dental implant system of claim 1, wherein the connector portion of the abutment comprises an insertion end and a tapered portion having a variable diameter, and wherein the tapered portion is configured such that the diameter of the tapered portion increases moving in a coronal direction.

14. The dental implant system of claim 13, wherein the insertion end of the connector portion is substantially hexagonal.

15. The dental implant system of claim 1, wherein the connector portion and the transition portion of the abutment each have a diameter, and wherein the diameter of the transition portion is greater than the diameter of the connector portion, thereby defining an abutment surface for contact with the shoulder portion of the implant.

16. The dental implant system of claim 15, wherein, upon attachment of the connector portion of the abutment therein the internal cavity of the implant, the circumferential rings of the shoulder portion of the implant and the circumferential rings of the transition portion of the abutment cooperate to define a continuous series of spaced circumferential rings along the longitudinal axes of the implant and the transition portion.

17. The dental implant system of claim 1, wherein the abutment body portion has a maximum diameter ranging from about 2.00 mm to about 5.00 mm and a longitudinal length ranging from about 3.00 mm to about 7.00 mm.

18. The dental implant system of claim 1, wherein the abutment body portion has a longitudinal axis, wherein the abutment body portion is tapered at a taper angle relative to the longitudinal axis of the abutment body portion, and wherein the taper angle ranges from about 1 degree to about 15 degrees.

19. The dental implant system of claim 18, wherein the longitudinal axis of the abutment body is substantially axially aligned with the common longitudinal axis of the connection portion and the transition portion of the abutment.

20. The dental implant system of claim 18, wherein the longitudinal axis of the abutment body is angled at a selected angle relative to the common longitudinal axis of the connection portion and the transition portion of the abutment, and wherein the selected angle ranges from about 0 degrees to about 30 degrees.

21. The dental implant system of claim 18, wherein the abutment body portion comprises a head portion and a base portion positioned therebetween the transition portion and the head portion along the longitudinal axis of the abutment, wherein the head portion comprises a plurality of grooves spaced along the longitudinal axis of the abutment.

22. The dental implant system of claim 1, wherein the abutment body portion defines a margin proximate the transition portion, and wherein the margin of the abutment body portion has a radial width ranging from about 0.10 mm to about 1.00 mm.

23. The dental implant system of claim 1, wherein the abutment is configured to engage a coping member.

24. The dental implant system of claim 23, wherein the coping member has an inner surface that defines an internal cavity configured to receive the abutment body portion.

25. The dental implant system of claim 24, wherein the coping member has an outer surface and a variable circumference, wherein the coping member comprises a plurality of retention rings secured around the circumference of the coping member and extending radially therefrom the outer surface of the coping member.

26. A dental implant system for securing a dental prosthesis therein a prepared site of a jawbone, the dental implant system comprising:
an implant having a longitudinal axis, the implant comprising:
a shoulder portion defining a coronal end of the implant and comprising a plurality of spaced circumferential rings, wherein the plurality of circumferential rings are spaced axially from one another by a separation distance, and wherein the shoulder portion is tapered in a coronal direction;
a implant body portion defining an apical end of the implant and having a longitudinal length and an implant thread, the implant thread substantially helically extending along at least a portion of the length of the implant body portion, wherein the implant body portion is tapered in an apical direction; and
an internal cavity defined therein the coronal end of the implant and extending along the longitudinal axis of the implant therethrough the shoulder portion and at least a portion of the implant body portion; and
an abutment comprising:
a connector portion configured for selective secure attachment therein the internal cavity of the implant;
a transition portion configured to abut the shoulder portion of the implant, the transition portion comprising a plurality of spaced circumferential rings, wherein the plurality of circumferential rings are spaced axially from one another by the separation distance, and wherein the connector portion and the transition portion have a common longitudinal axis; and
an abutment body portion, wherein the abutment body portion is tapered in a coronal direction,
wherein, upon attachment of the connector portion of the abutment therein the internal cavity of the implant, the common longitudinal axis of the connector portion and the transition portion of the abutment is substantially axially aligned with the longitudinal axis of the implant.

27. A method for securing a dental prosthesis therein a prepared site of a jawbone in a subject, the method comprising:
providing an implant having a longitudinal axis, the implant comprising:
a shoulder portion defining a coronal end of the implant and comprising a plurality of spaced circumferential rings;
a implant body portion defining an apical end of the implant and having a longitudinal length and an implant thread, the implant thread substantially helically extending along at least a portion of the length of the implant body portion, wherein the implant body portion is tapered in an apical direction; and
an internal cavity defined therein the coronal end of the implant and extending along the longitudinal axis of the implant therethrough the shoulder portion and at least a portion of the implant body portion;
providing an abutment having a longitudinal length, the abutment defining an internal bore along its entire longitudinal length, the abutment comprising:
a connector portion;
a transition portion comprising a plurality of spaced circumferential rings, wherein the connector portion and the transition portion have a common longitudinal axis; and
an abutment body portion, wherein the abutment body portion is tapered in a coronal direction,
positioning the implant body portion therein the prepared site of the jawbone;
securely attaching the connector portion of the abutment therein the internal cavity of the implant such that the common longitudinal axis of the connector portion and the transition portion is substantially axially aligned with the longitudinal axis of the implant and the transition portion of the abutment abuts the shoulder portion of the implant;
inserting an abutment screw therein the internal bore of the abutment such that a threaded portion of the abutment screw is positioned therein the internal cavity of the implant;
securing the abutment screw therein the internal cavity of the implant; and
securing the dental prosthesis thereto the abutment.
